(19) United States
(12) Patent Application Publication
(10) Pub. No.: US 2012/0084109 A1
(43) Pub. Date: Apr. 5, 2012

(54) Decisioning Guidelines And Framework

(75) Inventors: Clifford Todd Barnett, Charlotte, NC (US); Ruben C. Berumen, Miami, FL (US); Jason Daniel Latta, Charlotte, NC (US); Richard Thomas Mattingly, JR., Charlotte, NC (US); HueiJan Ou, Charlotte, NC (US)

(73) Assignee: BANK OF AMERICA CORPORATION, Charlotte, NC (US)

(21) Appl. No.: 12/897,241

(22) Filed: Oct. 4, 2010

(51) Int. Cl. G06Q 10/00

(52) U.S. Cl. 705/7.13

(57) ABSTRACT

A system and method of identifying one or more locations eligible to perform a work function based on one or more filtering parameters is provided. The system and method may include receiving a first plurality of locations and filtering the first plurality of locations to identify a second plurality of locations eligible to perform an identified work function based on a first filtering parameter. The second plurality of locations may be further filtered to determine a third plurality of eligible locations, the third plurality of eligible locations being identified based on a second filtering parameter. In some examples, the third plurality of locations may be further filtered to identify a fourth plurality of eligible locations, the fourth plurality of eligible locations being identified based on a third filtering parameter.

### BACKGROUND

In today's corporate world, improvements in efficiency, reduction in costs and improvement in customer service are factors to success. Accordingly, companies are constantly striving to achieve these factors. However, increasing numbers and types of options for providing services, performing work functions, etc. may complicate business decisions. Further, subjective decision making at various levels within a business entity may result in inconsistent decisions throughout the business entity, which may result in additional complexities as companies strive to improve efficiency, reduce costs and improve customer service. Accordingly, decisioning guidelines and framework to filter out eligible solution options for various decisions would be advantageous.

### SUMMARY

The following presents a simplified summary in order to provide a basic understanding of some aspects of the present disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to one or more aspects, a system and method of identifying one or more locations eligible to perform an identified work function based on one or more filtering parameters is provided. The system and method may include receiving a first plurality of locations and filtering the first plurality of locations, based on a first filtering parameter, to identify a second plurality of locations eligible to perform the work function. In some examples, the first filtering parameter may be one of safety/security risk, communication skills desired, and capability maturity of the location. The system and method may further include filtering the second plurality of locations, based on a second filtering parameter, to identify a third plurality of eligible locations. The second filtering parameter may be another of safety/security risk, communication skills desired, and capability maturity of the location. In some examples, the system and method may further include filtering the third plurality of eligible locations, based on a third filtering parameter, to identify a fourth plurality of eligible locations. The third filtering parameter may be yet another of safety/security risk, communication skills desired, and capability maturity of the location.

In some examples, the fourth plurality of locations may be transmitted to a user for further analysis/evaluation. The user may then select a location to perform the work function from the fourth plurality of locations.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for filtering eligible locations based on one or more location filtering parameters according to one or more aspects described herein.

FIG. 3 illustrates additional details of the location filtering system of FIG. 2 according to one or more aspects described herein.

FIG. 4 illustrates one example method of filtering locations to identify eligible locations based on one or more filtering parameters according to one or more aspects described herein.

FIG. 5 illustrates another example method of filtering locations to identify eligible locations based on one or more filtering parameters according to one or more aspects described herein.

FIG. 6 illustrates one example user interface for identifying filtering parameters and/or a threshold for a filtering parameter according to one or more aspects described herein.

FIGS. 7-9 illustrate one example filtering arrangement based on first, second and third filtering parameters, according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

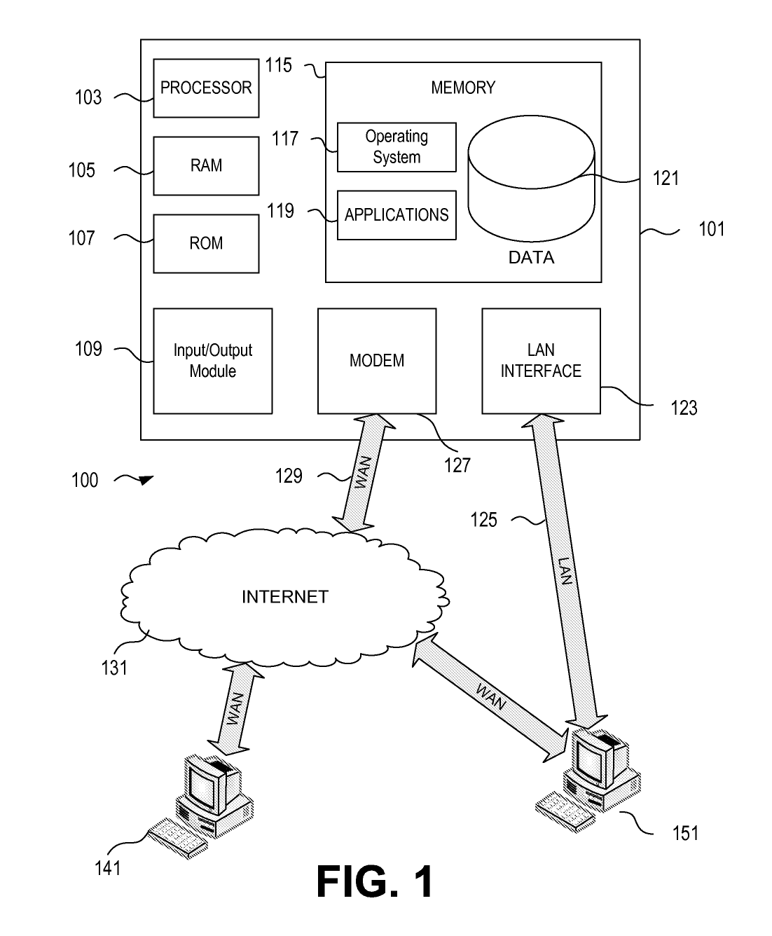

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses, companies, organizations, entities, etc. to evaluate and determine one or more locations eligible for performing a work function of the business, company, organization, entity, etc. For instance, various computing systems may be used to evaluate one or more locations and filter out locations not eligible to perform an identified work function. One or more filtering factors or parameters may be used to evaluate the locations and the locations remaining at the conclusion of the filtering process may be further evaluated or a location to perform the work function may be selected from those remaining locations, as will be discussed more fully below. A location may be any building, area within a building, street address, city, town, state, country, and the like at which the work function may be performed.

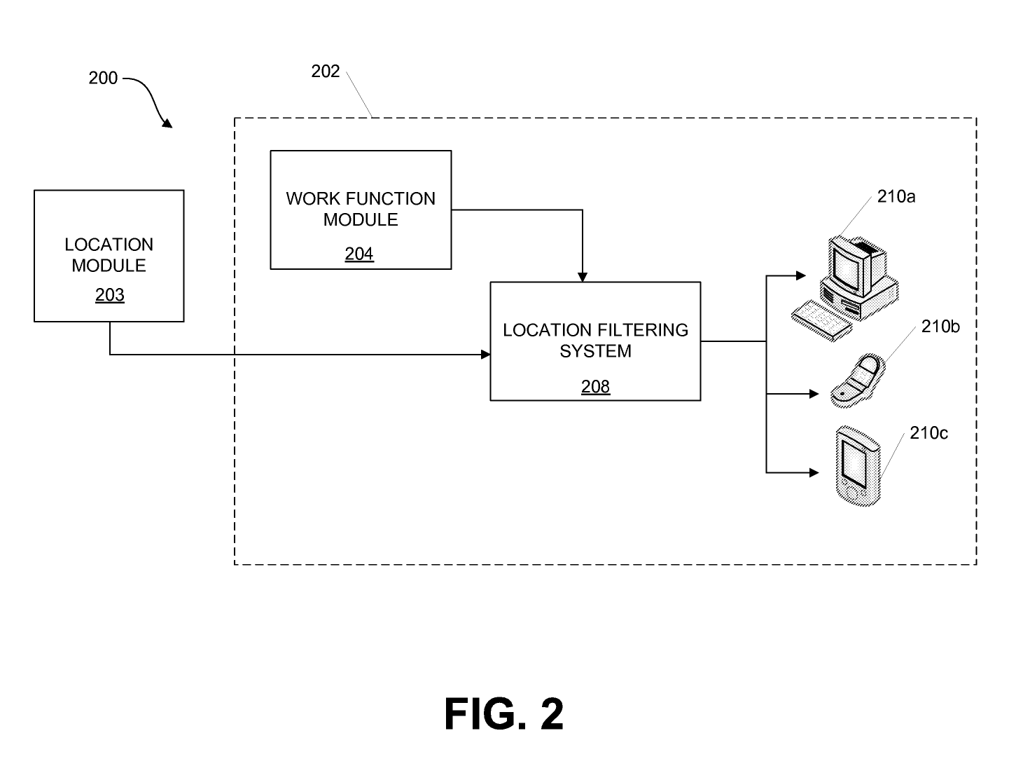

FIG. 2 illustrates one example system 200 for evaluating and filtering locations to determine locations eligible to perform an identified work function. The system 200, in some examples, may be located within the entity, organization, business, etc. 202 implementing the system. In other arrangements, the system 200 may be external to the entity implementing the system 200. The system 200 may include one or more work function modules 204. The work function module may be internal to the entity 202 implementing the system 200 (as shown in FIG. 2) or may be external to the entity 202. The work function module 204 may store a plurality of work functions, such as database administration, technical support, customer service support, and the like. In addition, the work function module 204 may store information related to or characteristics of the work functions, such as number of employees desired, communication skills desired, capability maturity desired, etc. Communication skills may include one or more desired languages, writing skills, and the like. In another example, the work function module 204 may also store information such as desired hours of operation, flexibility of staffing, etc.

The system 200 may further include one or more location modules 203. The location module 203 may store a plurality of locations in which one or more work functions may be performed. The location module 203 may further include information related to each location such as communication skills available (e.g., languages spoken, writing skills available, etc.) security or travel risk associated with a location, skill level of suppliers within a location, and the like.

A work function may be a new work function not currently being performed and for which a desirable or appropriate location for performing the work function is being identified, or an existing work function identified as having potential for efficiency improvement, cost savings, improved customer service, etc. by performing the work function in a location Accordingly, the identified work function and associated information may be transmitted from the work function module 204 to a location filtering system 208. The location filtering system 208 may also receive locations from the location module 203. The location filtering system 208 may receive user input, such as via computing devices 210a-210c, indicating various filter parameters or filter parameter settings. Accordingly, the location filtering system 208 may filter the received locations to identify one or more locations eligible to perform the identified work function. The identified locations may, in some examples, be transmitted to a user, such as to a user computer terminal 210a (e.g., laptop computer, desktop computer, notebook computer, etc.), a cell phone or smart phone 210b and/or a personal digital assistance (PDA) 210c. Communication between the user computing devices 210a-210c and the location filtering system 208 may be done via a network, such as the Internet, and/or via an internal communication system such as an intranet of the entity implementing the system.

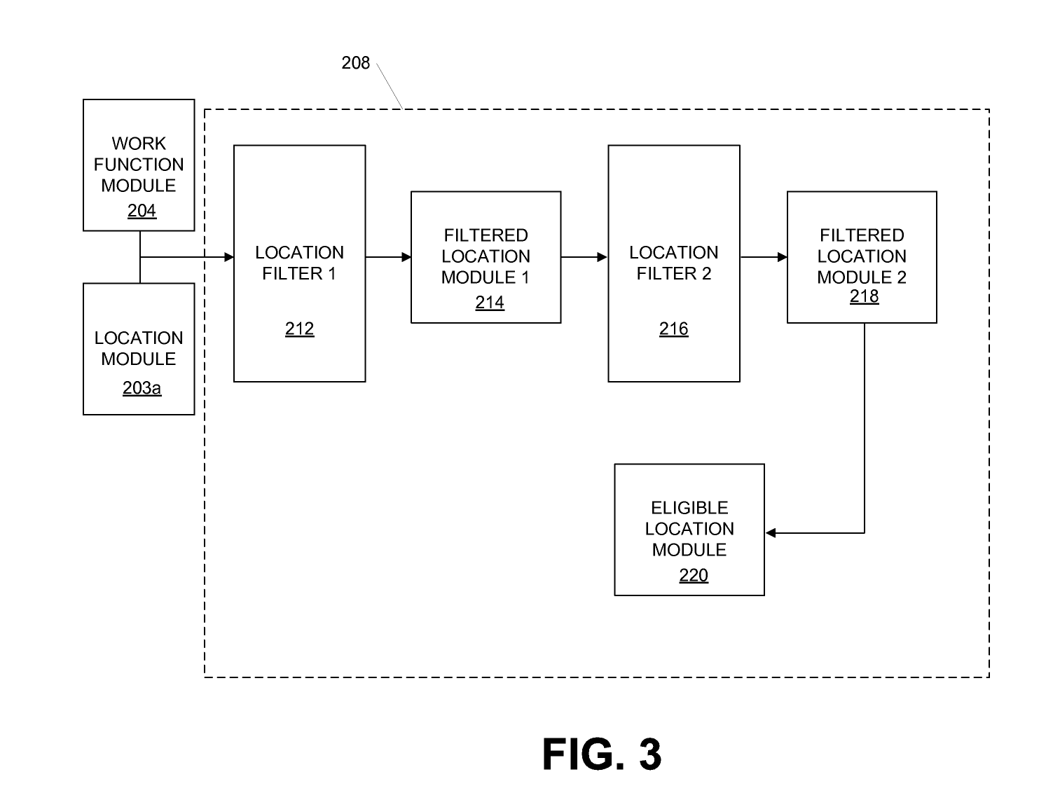

FIG. 3 illustrates one example location filtering system 208. As discussed above, a work function may be transmitted from the work function module 204 to the location filtering system 208, and a plurality of locations may be transmitted to the location filtering system 208 from the location module 203. The locations may be filtered at location filter 1 212 based on a first filtering factor or parameter. For instance, a user may indicate one or more filter parameters to remove ineligible locations and allow eligible locations to pass through. Accordingly, location filter 1 212 may implement a first filtering parameter in order to eliminate one or more of the received locations. In some examples, the first filtering parameter may include a security or safety risk associated with a location. For instance, a location having high crime may not be desirable for the work function and, accordingly, would be filtered out. Locations identified as eligible based on the first filtering parameter may be transmitted to filtered location module 1 214.

In some examples, the locations may be filtered through a plurality of location filters. For instance, the identified locations in filtered location module 1 214 may pass through another location filter, such as location filter 2 216. This location filter may include a second filtering parameter that may, in some examples, be different from the first filtering parameter. In some examples, the second filtering parameter may include desired communication skills, such as languages spoken, writing skills, etc. for performing the work function. Accordingly, locations from filtered location module 1 214 may be further filtered to identify locations having the desired communication skills. The identified locations may be stored in filtered location module 2 218. Although two filters are shown in FIG. 3, three, four, or more filters may be used to identify locations eligible to perform the work function. Upon conclusion of the filtering steps, locations remaining (i.e., locations eligible to perform the work function) may be transmitted to an eligible location module 220 for further evaluation, processing or selection as the location for performing the work function.

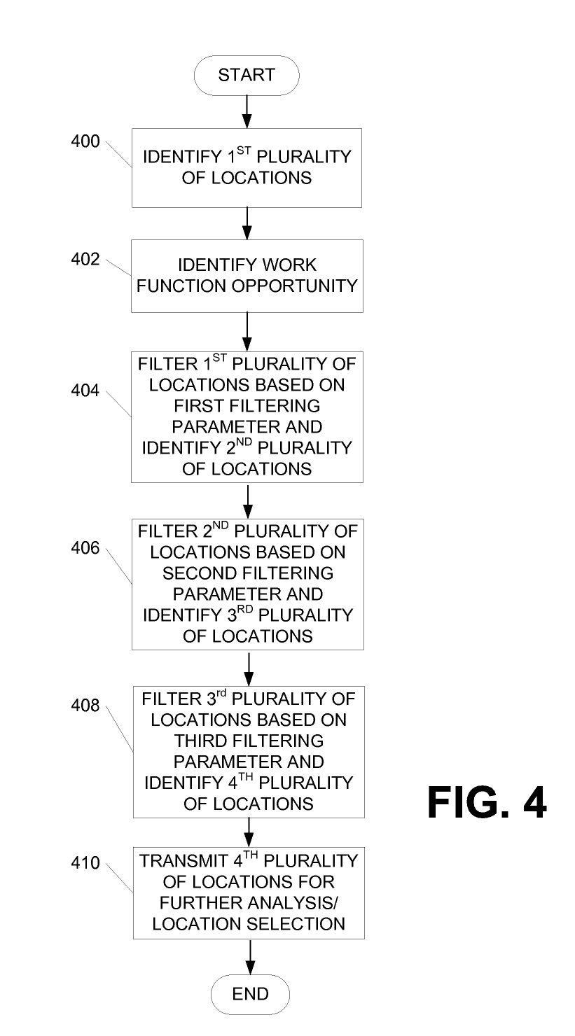

FIG. 4 illustrates one example method of filtering locations to identify locations eligible to perform a work function. In step 400, a first plurality of locations may be identified. The first plurality of locations may include all or a portion of locations available for performing any work function. As discussed above, a work function may be a new work function, not currently being performed, for which a desirable or appropriate location is being identified. In other examples, a work function may be a work function currently being performed for which a desirable or appropriate location is being identified. In other examples, the first plurality of locations may include locations in which the entity implementing the filtering system is able to perform work functions or is currently performing work functions. In step 402, a work function opportunity is identified. As discussed above, a work function opportunity may include a potential efficiency improvement, customer service improvement, cost savings, etc. associated with performing a work function in a particular location or type of location.

In step 404, the first plurality of location is filtered based on a first filtering parameter to identify a second plurality of locations. For instance, the first plurality of locations may be filtered based on one of safety and/or security risk, communication skills desired, capability maturity of the location, and the like. Locations meeting the filtering criteria may be identified and included in the second plurality of locations. In some arrangements, the locations may be associated with a score for each filtering criteria. For instance, the locations may have a score on a scale of 1 to 10 for each of safety/security risk, communication skills and/or capability maturity. The filtering parameters may then determine eligible locations based on the location score meeting a predetermined threshold score for each filtering parameter. Alternatively, the locations may be categorized for each filtering parameter (e.g., for capability maturity the locations may be categorized as mature, credible, emerging, or non-existing) and the filter may identify as eligible locations in predetermined categories. The threshold levels for eligibility may be input by a user, such as via use computing devices 210a-210c in FIG. 2. In still other examples, the locations may be associated with a keyword, such as “Spanish,” “security,” “writing skills,” etc. and the filters may identify eligible locations based on one or more keywords associated with each location.

In step 406, the second plurality of locations may be further filtered based on a second filtering parameter to identify a third plurality of locations (of the second plurality of locations) that may be eligible to perform the work function. For instance, if the first filtering parameter identified locations with an acceptable safety/security risk, the second filtering parameter may identify locations eligible based on communication skills. In step 408, the third plurality of locations may be further filtered based on a third filtering parameter to identify a fourth plurality of eligible locations (of the third plurality). Continuing the above example, the third filtering parameter may be capability maturity of the location. Capability maturity may, in some examples, include market activity of the capability, scalability of resources within the location, experience working in the location, number of suppliers within the location, and the like. For instance, a location having well developed technology capabilities may be better suited to performing the identified work function than locations having minimal technology capability. If the system provides three filters, this fourth plurality of locations may be transmitted (such as, to a user) for further evaluation, analysis or selection as the desired location in step 410.

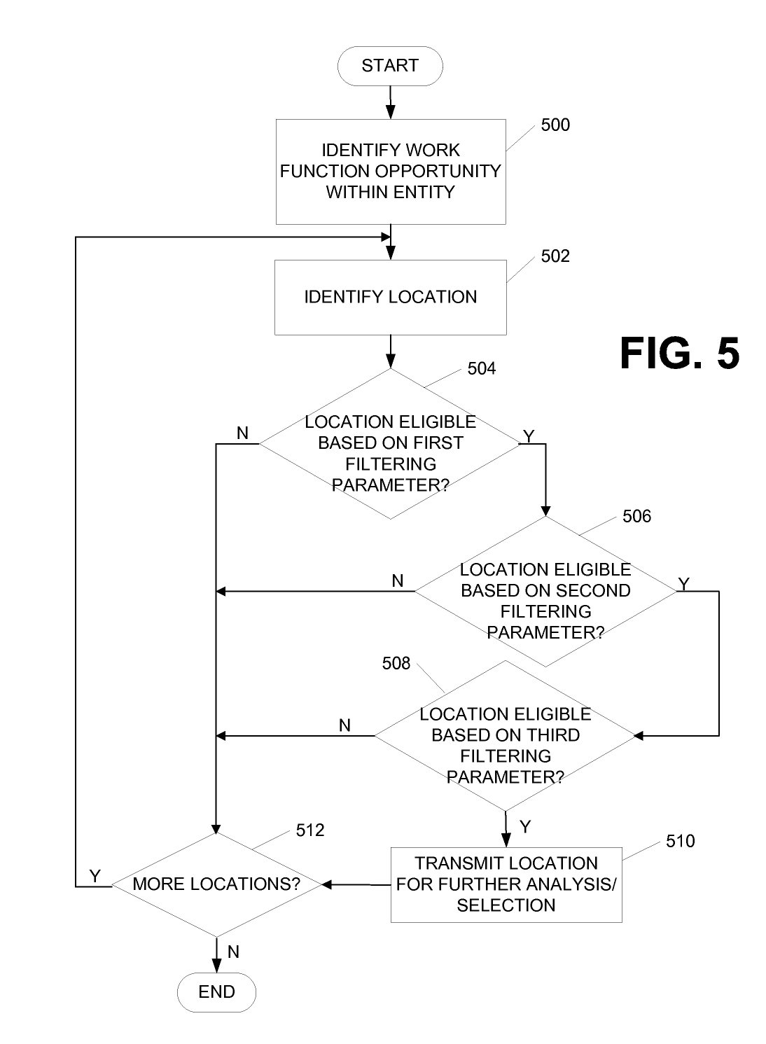

FIG. 5 illustrates another example method of filtering locations to identify locations eligible to perform a work function. In step 500 a work function opportunity may be identified. The work function may be a work function within the entity implementing the filtering system. In step 502, a location may be identified. The location may be one of a plurality of locations that may be eligible for performing the work function. In step 504, a determination is made as to whether the identified location is eligible to perform the identified work function based on a first filtering parameter. In some examples, the filtering parameter may include communication skills desired, safety/security risk, capability maturity, etc. If the location is not eligible in step 504, a determination is made as to whether additional locations are available for evaluation in step 512. If additional locations are available, another location may be identified in step 502 and the process continues. If no additional locations are available, the process may end.

If the location is eligible based on the first filtering parameter in step 504, a determination may be made in step 506 as to whether the location is eligible to perform the work function based on a second filtering parameter. If the location is not eligible, a determination of whether there are additional locations to evaluate is made in step 512. If the location is eligible, a determination is made in step 508 as to whether the location is eligible based on a third filtering parameter. If the location is not eligible, whether additional locations are available is determined in step 512. If the location is eligible in step 508, the location may be transmitted, such as to a user, for further evaluation and/or selection in step 510. As discussed above, a determination of whether additional locations are available for evaluation is made in step 512 and, if so, the process may return to step 502 to identify another location for evaluation. Although three filtering steps are shown in the figure, more or fewer filtering steps, filters and/or filtering parameters may be used without departing from the invention.

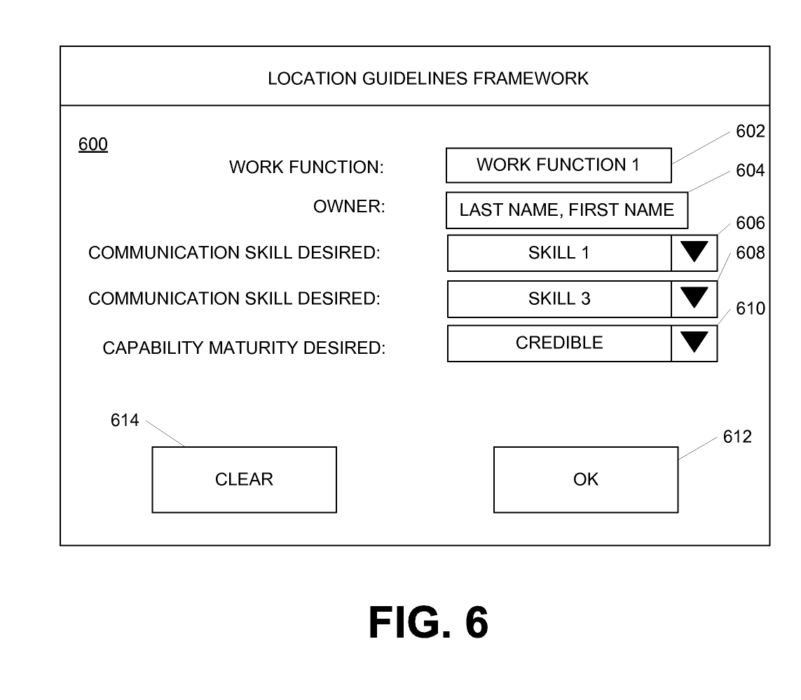

FIG. 6 illustrates one example user interface 600 for providing filtering parameters and/or threshold levels for the filtering parameters. Fields 602 and 604 identify the work function and an owner of the work function, respectively. Field 606 provides for identification of a first or primary desired communication skill, while field 608 provides for identification of a second or additional desired communication skill. Field 610 provides a threshold level of maturity level of capability desired for the location. Fields 606, 608 and 610 may include, in some examples, a drop down menu of available options for selection. Alternatively, a user may input a desired value in those fields by clicking, double-clicking, etc. in the field and inserting the desired value. Although communication skills and capability maturity values are shown in FIG. 6, additional filtering parameters (such as safety/security risk) and/or thresholds may be provided. Once the desired parameters and/or values are identified, a user may select “OK” option 612 in order to begin the location filtering/identification process. Alternatively, a user may select “CLEAR” option 614 in order to clear the values appearing and/or return the values to a default setting.

One illustrative example of various aspects of the present disclosure is provided below. However, this is merely one example and nothing in the specification should be viewed as limiting the disclosure to only the features discussed below.

In one example, a business entity, Company A, may identify a work function, Work Function A, that may have one or more advantages to being performed in a variety of different locations. .FIX THIS For instance, Work Function A may be a newly defined work function and a location for performing the work function is desired. Accordingly, a filtering system, such as location filtering system 208 in FIG. 2, may receive the identified work function (e.g., Work Function A) and any associated information, such as characteristics of the work performed, desired communication skills, capability maturity, etc. The system may also receive a plurality of locations that may be eligible to perform the work function.

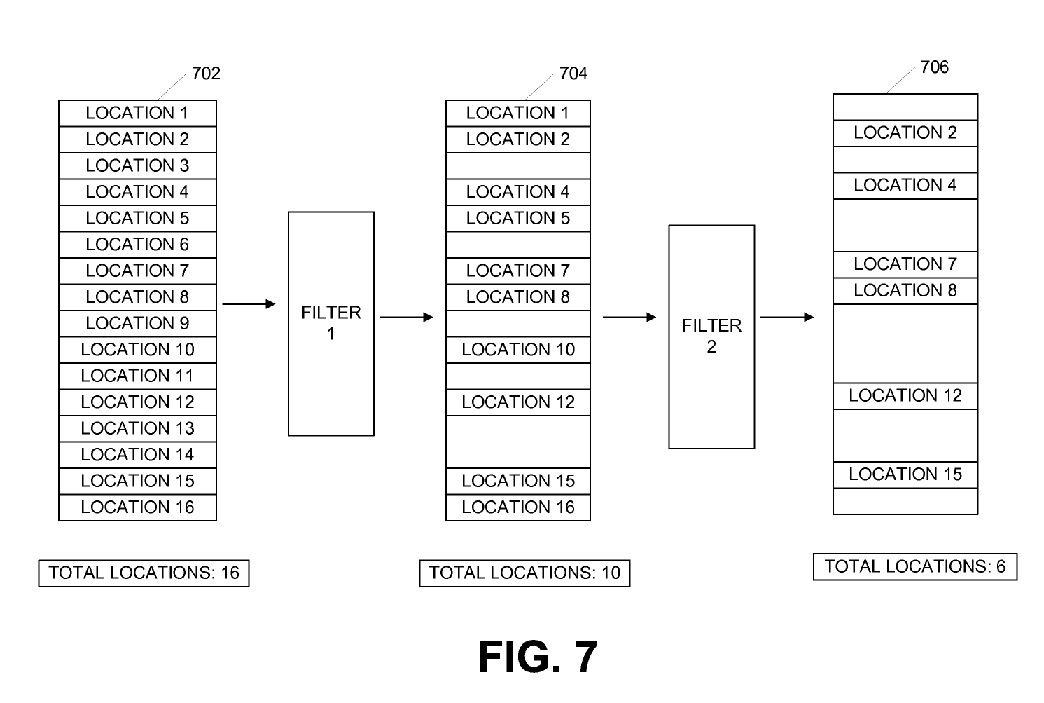

The system may filter the received locations based on a first filtering parameter, such as safety and/or security risk. FIG. 7 illustrates one example of this filtering step and, in this example, includes two filtering steps. Initially, table 702 illustrates the first plurality of locations that may be eligible to perform the work function. Sixteen locations are available for evaluation in table 702. The initial filtering step may remove all locations of the first plurality of locations that are considered unsuitable to perform a work function. The remaining locations are shown in table 704. Ten locations remain eligible. These locations may then be further filtered based on security risk filter parameter. The remaining eligible locations are shown in table 706 and six remain eligible.

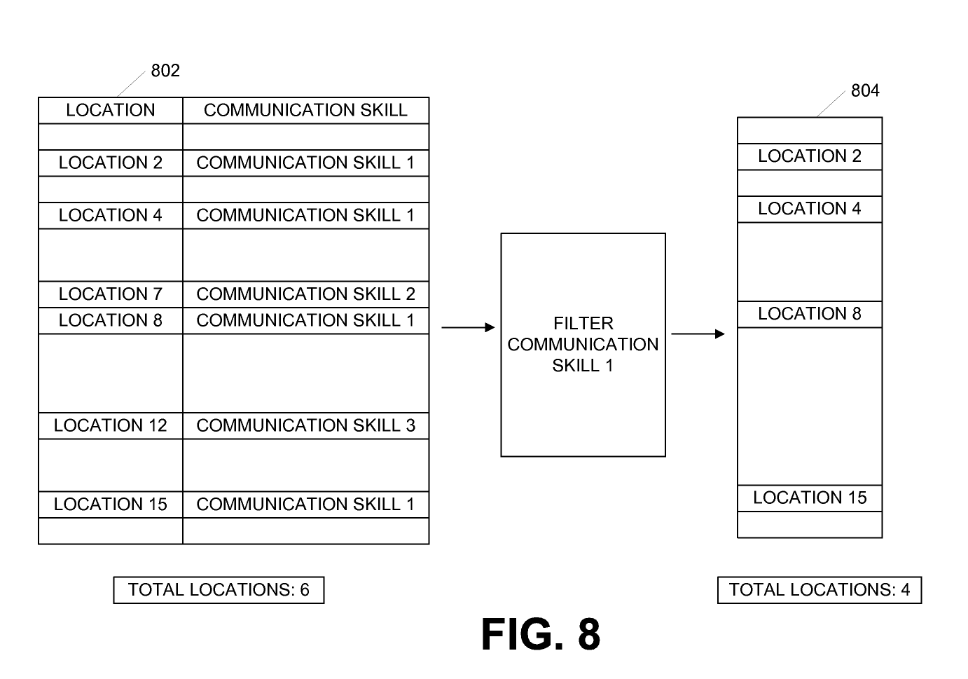

A second filtering parameter may be used to further determine eligible locations. FIG. 8 illustrates filtering based on this second filtering parameter. In some arrangements, the second filtering parameter may be desired communication skills, such as languages spoken, writing skills, etc. If communication skill 1 is the desired communication skill, of the six remaining locations from the first filtering step in FIG. 7 (shown in table 802), four have communication skill 1 identified and will thus pass through the filter and be deemed eligible based on this filtering parameter. The remaining four locations are shown in table 804.

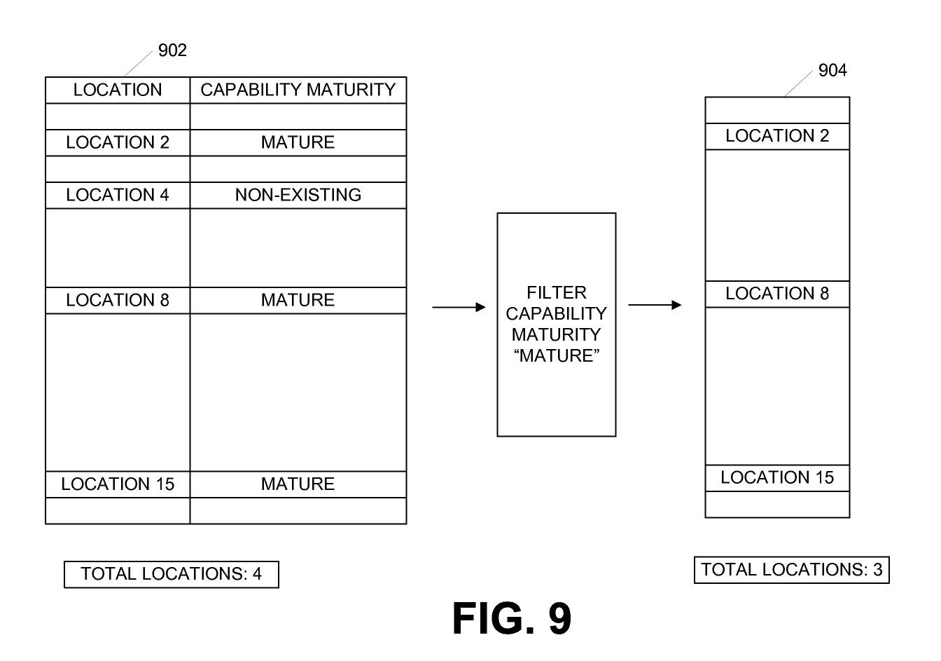

FIG. 9 illustrates a third and, in this example, final filtering step. The eligible four locations (table 902) from the previous filtering step are filtered based on a desired capability maturity of the location being “mature.” Accordingly, three of the four remaining locations are eligible based on this criteria and are shown in table 904. These remaining three locations may then be transmitted to a user for further evaluation, analysis and/or selection as the location to perform the work function.

Although three filters are shown in this example, more or fewer filters may be used. Further, the order of the filtering parameters implemented may be changed without departing from the disclosure.

The above described location filtering system and framework may provide a consistent, repeatable decisioning tool to aid in determining where a work function may be performed and/or recommending advantageous locations for performing the work function. Use of the system and method described herein may aid in providing consistency across the process by relying on substantially similar factors, parameters, etc. for each location decision, thereby reducing the use of subjective factors in the location decisioning process.

The methods and features recited herein may further be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present disclosure. The description is thus to be regarded as illustrative instead of restrictive on the present disclosure.

What is claimed is:

1. A method, comprising:
identifying, by a location filtering computing device, a first plurality of locations;
receiving, by the location filtering computing device, a work function including a work function characteristic;
receiving, by the location filtering computing device, a first location filtering parameter;
determining, by the location filtering computing device, a second plurality of locations from the first plurality of locations eligible to perform the work function based on the work function characteristic and the first location filtering parameter;
receiving, by the location filtering computing device, a second location filtering parameter;
determining, by the location filtering computing device, a third plurality of locations of the second plurality of locations eligible to perform the work function based on the second location filtering parameter;
receiving, by the location filtering computing device, a third location filtering parameter; and
determining, by the location filtering computing device, a fourth plurality of locations of the third plurality of locations eligible to perform the work function based on the third location filtering parameter.

2. The method of claim 1, wherein the first, second and third filtering parameters are each different parameters.

3. The method of claim 1, wherein the first filtering parameter is a security risk associated with the locations of the first plurality of locations.

4. The method of claim 1, wherein the second filtering parameter is a language spoken by the locations of the second plurality of locations.

5. The method of claim 1, wherein the third filtering parameter is a capability maturity of the locations of the third plurality of locations.

6. The method of claim 5, wherein the capability maturity of the locations includes at least one of: market activity of the capability, scalability of resources within the location, experience working in the location, and number of suppliers within the location.

7. The method of claim 1, further including identifying a desired location in which to perform the work function from the fourth plurality of locations.

8. The method of claim 7, wherein identifying a desired location includes assessing additional location factors including at least one of: information and cyber security, distance to location, concentration of work within a location, and cost associated with setup for work function within the location.

9. A method, comprising:
identifying, by a location filtering computing device, a first plurality of locations;
receiving, by the location filtering computing device, a work function including a work function characteristic;
receiving, by the location filtering computing device, a first location filtering parameter and a second location filtering parameter;
determining, by the location filtering computing device, a second plurality of locations from the first plurality of locations eligible to perform the work function based on the work function characteristic and the first location filtering parameter; and
determining, by the location filtering computing device, a third plurality of locations of the second plurality of locations eligible to perform the work function based on the second location filtering parameter.

10. The method of claim 9, wherein the first location filtering parameter is one of:
safety/security risk, communication skills desired and capability maturity of the location.

11. The method of claim 10, wherein the second location filtering parameter is another of safety/security risk, communication skills desired and capability maturity of the location.

12. The method of claim 9, further including receiving, at the location filtering system, a third location filtering parameter and determining, by the location filtering system, a third plurality of locations from the second plurality of locations eligible to perform the work function based on the work function characteristic and the third location filtering parameter.

13. The method of claim 12, wherein the third location filtering parameter is another of safety/security risk, communication skills desired and capability maturity of the location.

14. One or more non-transitory computer readable media storing computer readable instructions that, when executed, cause an apparatus to:
identify, by a location filtering computing device, a first plurality of locations;
receive, by the location filtering computing device, a work function including a work function characteristic;
receive, by the location filtering computing device, a first location filtering parameter, a second location filtering parameter, and a third location filtering parameter;
determine, by the location filtering computing device, a second plurality of locations from the first plurality of locations eligible to perform the work function based on the work function characteristic and the first location filtering parameter;
determine, by the location filtering computing device, a third plurality of locations of the second plurality of locations eligible to perform the work function based on the second location filtering parameter; and
determine, by the location filtering computing device, a fourth plurality of locations of the third plurality of locations eligible to perform the work function based on the third location filtering parameter.

15. The one or more non-transitory computer readable media of claim 14, wherein the first, second and third filtering parameters are each different parameters.

16. The one or more non-transitory computer readable media of claim 14, wherein the first location filtering parameter is one of: safety/security risk, communication skills desired and capability maturity of the location.

17. The one or more non-transitory computer readable media of claim 16, wherein the second location filtering parameter is another of safety/security risk, communication skills desired and capability maturity of the location.

18. The one or more non-transitory computer readable media of claim 17, wherein the third filtering parameter is a capability maturity of the locations of the third plurality of locations.

19. The one or more non-transitory computer readable media of claim 18, wherein the capability maturity of the locations includes at least one of: market activity of the capability, scalability of resources within the location, experience working in the location, number of suppliers within the location.

20. The one or more non-transitory computer readable media of claim 14, further including identifying a desired location in which to perform the work function from the fourth plurality of locations.

21. The one or more non-transitory computer readable media of claim 20, wherein identifying a desired location includes assessing additional location factors including at least one of: information and cyber security, distance to location, concentration of work within a location, and cost associated with setup for work function within the location.

22. An apparatus comprising:
a processor; and
memory operatively coupled to the processor and storing computer readable instructions that, when executed, cause the apparatus to:
identify, by a location filtering system, a first plurality of locations;
receive, by the location filtering system, a work function including a work function characteristic;
receive, by the location filtering system, a first location filtering parameter, a second location filtering parameter, and a third location filtering parameter;
determine, by the location filtering system, a second plurality of locations from the first plurality of locations eligible to perform the work function based on the work function characteristic and the first location filtering parameter;
determine, by the location filtering system, a third plurality of locations of the second plurality of locations eligible to perform the work function based on and the second location filtering parameter; and
determine, by the location filtering system, a fourth plurality of locations of the third plurality of locations eligible to perform the work function based on the third location filtering parameter.

23. The apparatus of claim 22, wherein the first location filtering parameter is one of: safety/security risk, communication skills desired and capability maturity of the location.

24. The apparatus of claim 23, wherein the second location filtering parameter is another of safety/security risk, communication skills desired and capability maturity of the location.

25. The apparatus of claim 24, wherein the third filtering parameter is a capability maturity of the locations of the third plurality of locations.
